(19) United States
(12) Patent Application Publication
(10) Pub. No.: US 2011/0100585 A1
(43) Pub. Date: May 5, 2011

(54) COOLING APPARATUS

(75) Inventors: Jonas Hohenstein, Ludwigsburg-Ossweil (DE); Paul Hurmer, Stuttgart (DE); Armin Schweizer, Moensheim (DE)

(73) Assignee: DR. ING. H.C.F. PORSCHE AKTIENGESELLSCHAFT, Stuttgart (DE)

(21) Appl. No.: 12/914,665

(22) Filed: Oct. 28, 2010

(30) Foreign Application Priority Data
Nov. 4, 2009 (DE) 10 2009 051 864.9

(51) Int. Cl. B60H 1/00; F28F 9/00

(52) U.S. Cl. 165/41; 165/67

(57) ABSTRACT

A cooling apparatus is provided for an electrical device that gives off heat during operation. The cooling apparatus has a housing (2) with a cavity and inlet and outlet openings (15, 18) that communicate with the cavity. A cooling insert (8) is disposed in the cavity and has depressions (21, 22, 31, 32) that extending in a meandering manner along surfaces of the cooling insert (8). The depressions and opposed surfaces of the housing (2) form cooling ducts that extend between the inlet and outlet openings (15, 18) to accommodate a flow of a cooling medium.

### CROSS-REFERENCE TO RELATED APPLICATION

This application claims priority under 35 USC 119 to German Patent Application No. 10 2009 051 864.9, filed on Nov. 4, 2009, the entire disclosure of which is incorporated herein by reference.

### BACKGROUND OF THE INVENTION

1. Field of the Invention

The invention relates to a cooling apparatus for an electrical device that gives off heat during operation. The invention also relates to an electrical device with a cavity in which a cooling apparatus is disposed and to a motor vehicle having such an electrical device.

2. Description of the Related Art

German patent specification DE 101 91 092 B3 discloses a construction kit for a switchgear cabinet having a cooling air guide system with air guide plates arranged in a region of a roof element. German laid-open specification DE 32 28 368 A1 discloses a housing for electrical devices with various cooling construction kits that comprise only mechanical accessories matched to the respective cooling principle, and variable housing covers.

The object of the invention is to optimize a cooling apparatus, in particular in terms of the cooling power and the flow of cooling medium.

### SUMMARY OF THE INVENTION

The invention relates to a cooling apparatus for an electrical device that gives off heat during operation. The cooling apparatus has a cooling insert with cooling ducts through which a cooling medium flows. The cooling insert is arranged in a closed cooling-medium-tight housing that has at least two openings for a cooling medium stream to enter and exit. The cooling apparatus is a closed system which, for cooling purposes, and can be arranged in or on the electrical device. The cooling insert and/or the housing can be changed to achieve different cooling powers. More particularly, the housing preferably has a plurality of cooling inserts for different applications. Thus, a cooling apparatus optimum for a particular cooling need advantageously can be provided in a simple manner by combining the single housing with an appropriate cooling insert.

The cooling insert preferably has an insert body with elongate depressions that represent the cooling ducts. The insert body preferably is of substantially cuboid design. The size and shape of the cuboid is matched to the size and shape of the housing. The cooling ducts can be varied as desired by virtue of the length, depth and course of the depressions.

The housing preferably has a removable housing cover that closes the housing in a cooling-medium-tight manner. As a result, insertion and replacement of the cooling insert is simplified. The housing cover can be attached to the housing, for example, with the aid of screw connections and preferably with the interposition of a suitable seal.

The surface of the cooling insert that faces the housing cover preferably has depressions that run in a meandering manner from an inlet region to an outlet region for the cooling medium. The depressions preferably extend over the entire surface of the cooling insert to improve heat transfer between the cooling medium and the housing cover.

The surface of the cooling insert that faces away from the housing cover preferably has depressions that run in a meandering manner from the inlet region to the outlet region for the cooling medium. The depressions in the surfaces of the cooling insert that are averted from one another preferably extend from a common inlet region to a common outlet region. As an alternative, two separate inlet regions and two separate outlet regions can be provided in each case.

The housing base and/or the housing cover may have cooling ribs that run in the longitudinal direction of the cooling ducts and project into the adjacent depressions in the cooling insert. The cooling ribs improve heat transfer between the cooling medium and the housing cover or the housing.

The housing preferably has connection openings for cooling medium lines in the inlet and outlet regions. The connection openings may have threads to threadedly engage corresponding connection pieces.

The cooling apparatus comprises various cooling inserts that allow different cooling powers in the closed housing, depending on requirements. The various cooling inserts preferably have the same external dimensions and differ only in terms of the design and the dimensions of the depressions.

The invention also relates to an electrical device having a cavity in which the above-described cooling apparatus is arranged. The size and shape of the cavity preferably matches the external size and shape of the housing of the cooling apparatus. The electrical device may be an electrical converter, in particular an electrical double converter.

The invention also relates to a motor vehicle having the above-described electrical device. The motor vehicle is preferably an electric vehicle or a hybrid vehicle.

Further advantages, features and details of the invention can be gathered from the following description, in which an exemplary embodiment is described in detail with reference to the drawing.

### BRIEF DESCRIPTION OF THE DRAWINGS

FIG. 1 is a perspective illustration of a cooling apparatus according to the invention.

FIG. 2 is a cross-section taken along line II-II in FIG. 1.

FIG. 3 is a cross-section similar to FIG. 2, but showing an alternate cooling insert.

### DETAILED DESCRIPTION OF THE PREFERRED EMBODIMENT

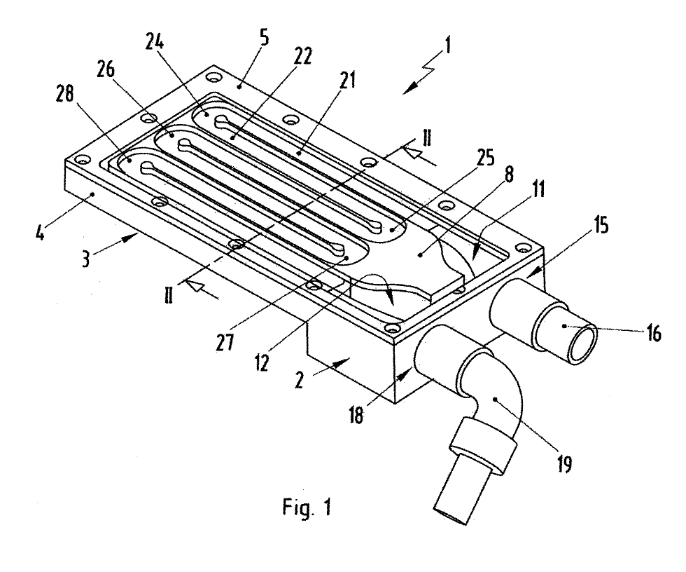

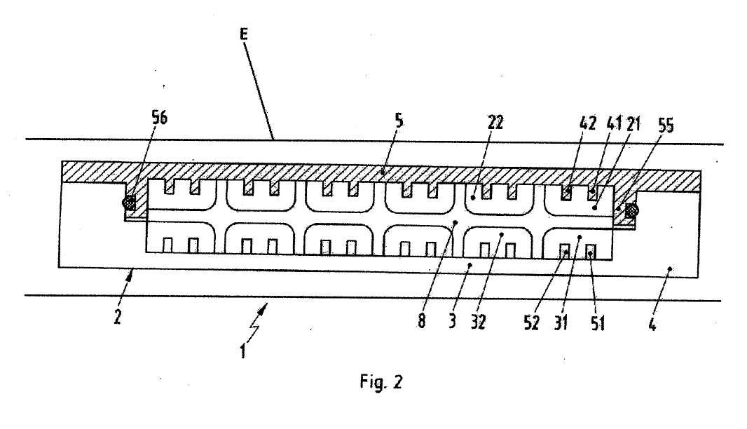

A cooling apparatus in accordance with the invention is identified by the numeral 1 in FIGS. 1 and 2. The cooling apparatus 1 has a housing 2 with a generally rectangular plate-shaped base 3. Side walls 4 project from the base 3 to define a substantially cubic cavity in the housing 2. A housing cover 5 is illustrated in a transparent manner in FIG. 1 and enables the cavity of the housing 2 to be closed. The housing 2 may be dimensioned to be inserted into an electrical device E that requires cooling. For example the electrical device E may be part of a vehicle V, such as an electric vehicle or a hybrid vehicle.

The cooling apparatus 1 further includes a cooling insert 8 accommodated in the cavity of the housing 2. The cooling insert 8 has two recesses that define an inlet region 11 and an outlet region 12 for a cooling medium. The cooling medium preferably is a cooling liquid, such as water with relevant additives.

The housing 2 has an inlet opening 15 in the inlet region 11 and an inlet connection line 16 is connected to the inlet opening 15. The housing 2 also has an outlet opening 18 in the outlet region 12 and an outlet connection line 19 is connected to the outlet opening 18. A cooling medium stream is fed to the inlet region 11 via the inlet connection line 16 and the cooling medium stream is discharged from the outlet region 12 via the outlet connection line 19.

The surface of the cooling insert 8 that faces the cover 5 has elongate channels or depressions 21, 22 that are closed by the cover 5 to define cooling ducts that proceed from the inlet region 11. The cooling ducts change direction by 180 degrees in deflection regions 24 to 28 so that the cooling medium stream is deflected in a meandering manner from the inlet region 11 to the outlet region 12.

FIG. 2 shows that analogous elongate channels or depressions 31, 32 are formed in the surface of the cooling insert 8 that faces the base 3 of the housing 2. The elongate depressions 31, 32 are closed by the base 3 to define cooling ducts in the same way that the depressions 21, 22 in surface of the cooling insert 8 that face the cover 5 form cooling ducts. Cooling ribs 51, 52 project from the base 3 into the elongate depressions 31 and cooling ribs 41, 42 extend from the cover 5 into the elongate depressions 21.

The housing cover 5 has a peripheral web 55 that engages in the housing 2 between the cooling insert 8 and the housing side walls 4. A seal 56 is accommodated in a corresponding groove between the housing side walls 4 and the peripheral web 55. The seal 56 closes off the interior of the housing 2 containing the cooling insert 8 from the surrounding area in a cooling-medium-tight manner.

The cooling apparatus 1 defines a closed module that can be used in a variable manner for cooling, for example, electronic components. The cooling power of the cooling apparatus 1 can be matched to cooling requirements of different applications by selecting the cooling insert 8 of appropriate design, both at the top of the cooling insert 8 facing the cover 5 and at the bottom of the cooling insert 8 facing the base 3. The design of the cooling insert 8 enables the cooling power and the cooling power distribution to be varied in a simple manner, depending on cooling requirements and also enables the cooling power and the cooling power distribution to be allocated between the cooling areas.

The configuration of the cooling ducts illustrated in FIGS. 1 and 2 can provide a very homogeneous cooling power. An operation-induced drop in pressure can be kept low by the cooling ducts, which have optimized flow in the deflection regions 24 to 28. Cooling medium can flow through the cooling ducts in both directions. The cooling medium used can be, for example, water.

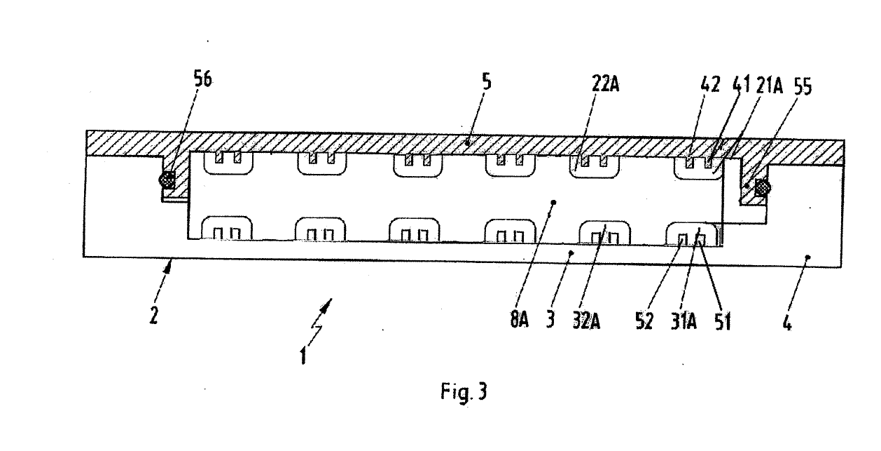

Only one cooling insert 8 is shown in the FIGS. 1 and 2. However, plural cooling inserts 8, 8A may be made and a selected one can be used in accordance with the cooling needs of a particular electrical apparatus E. In this regard FIG. 3 shows an alternate cooling insert 8A that can be used with the housing 2 of FIGS. 1 and 2. The alternate cooling insert 8A has depressions 21A, 22A, 31A, 32A that are shallower than the depressions 21, 22, 31, 32 of the cooling insert 8 in FIG. 2 thereby altering the flow of the cooling medium and affecting the cooling ability. In still other cooling inserts, the depressions may be deeper, wider or narrower to alter the flow of the cooling medium from the inlet region 11 to the outlet region 12 in other ways to match the cooling needs of a particular electrical device. Similarly, the depressions 21, 22, 31, 32 in one cooling insert 8 can meander in a different manner than the depressions 21, 22, 31, 32 to alter the flow of the cooling medium.

What is claimed is:

1. A cooling apparatus for an electrical device that gives off heat during operation, the cooling apparatus comprising: a cooling insert and a closed cooling-medium-tight housing in which the cooling insert is disposed, at least one inlet opening and at least one outlet opening formed in the housing, opposed facing surfaces of the cooling insert and the housing being configured to define cooling ducts extending between the inlet and outlet openings for accommodating a flow of cooling medium from the inlet opening to the outlet opening.

2. The cooling apparatus of claim 1, wherein the cooling insert comprises an insert body with elongate depressions that cooperate with opposed facing surfaces of the housing to define the cooling ducts.

3. The cooling apparatus of claim 2, wherein the housing comprises a removable cover that closes the housing in a cooling-medium-tight manner.

4. The cooling apparatus of claim 3, wherein the cooling insert has a first surface that faces the cover, the first surface of the insert being formed with first depressions that run in a meandering manner from an inlet region to an outlet region, the first depressions being closed by the cover to define the cooling ducts for accommodating the cooling medium.

5. The cooling apparatus of claim 4, wherein the cooling insert has a second surface opposite the first surface, the second surface facing a base of the housing and being formed with second depressions that run in a meandering manner from the inlet region to the outlet region, the second depressions being closed by the base of the housing to define the cooling ducts for accommodating the cooling medium.

6. The cooling apparatus of claim 5, wherein the base of the housing has cooling ribs that extend along the cooling ducts and project into the second depressions in the cooling insert.

7. The cooling apparatus of claim 4, wherein the cover of the housing has cooling ribs that extend along the cooling ducts and project into the first depressions in the cooling insert.

8. The cooling apparatus of claim 4, wherein the housing has inlet and outlet connection openings in the inlet and outlet regions, the inlet and outlet connection openings being configured for connection with inlet and outlet cooling medium lines.

9. An electrical device having a cavity in which the cooling apparatus of claim 1 is arranged.

10. A motor vehicle having the electrical device of claim 9.

11. A cooling system for at least one electrical device that gives off heat during operation, comprising:
a housing with a cavity and inlet and outlet openings communicating with the cavity; and
a plurality of cooling inserts each of which is dimensioned and configured to fit in the cavity of the housing, each of the inserts having depressions extending between the inlet and outlet openings of the housing, the depressions and opposed surfaces of the housing defining cooling ducts for accommodating a flow of cooling medium from the inlet opening to the outlet opening, the depressions in at least one of the cooling inserts being different from the depressions in another of the cooling inserts, the cooling inserts being selected to achieve an appropriate flow of the cooling medium for the electrical device.

12. The system of claim 11, wherein the housing comprises a removable cover (5) that closes the housing in a cooling-medium-tight manner.

13. The system of claim 12, wherein each of the cooling inserts has a first surface that faces the cover, the first surface of the insert being formed with first depressions that run in a meandering manner from an inlet region to an outlet region, the first depressions being closed by the cover to define the cooling ducts for accommodating the cooling medium.

14. The system of claim 13, wherein each of the cooling inserts has a second surface opposite the first surface, the second surface facing a base of the housing and being formed with second depressions that run in a meandering manner from the inlet region to the outlet region, the second depressions being closed by the base of the housing to define the cooling ducts for accommodating the cooling medium.

15. The system of claim 14, wherein the base of the housing has cooling ribs that extend along the cooling ducts and project into the second depressions in the cooling insert.

16. The system of claim 12, wherein the cover of the housing has cooling ribs that extend along the cooling ducts and project into the first depressions in the cooling insert.
